(19) United States
(12) Patent Application Publication
(10) Pub. No.: US 2007/0008290 A1
(43) Pub. Date: Jan. 11, 2007

(54) Switch device for showing changing interval

(76) Inventor: Li Du, Dalian City (CN)

Correspondence Address: BEYER WEAVER & THOMAS, LLP, P.O. BOX 70250, OAKLAND, CA, 94612-0250, US

(21) Appl. No.: 11/479,552

(22) Filed: Jun. 30, 2006

(30) Foreign Application Priority Data
Jan. 5, 2004 (WO) PCT/CN04/00012

(51) Int. Cl. G09G 5/00

(52) U.S. Cl. 345/168

(57) ABSTRACT

The present invention relates to a switch, and a signal generating switch device which can provide continuous real-time response. The problem to be resolved is to provide a method in order to realize a switch device which permits the pole is in a dynamic state in which the pole can change the interval and direction relative to the throw before ad after it contacts the throw during the continuous operation period. The manufacturing method is as follows: firstly, several throws are uniformly provided on an inner concave of a throw carrier in a plate shape and ensured to be on the same circumference. Second, a pole in a pin shape is fixed on the top of a pole carrier in a cap shape which can cover the top part of a finger and ensured to be vertical to the top face of the cap. Finally, the wires with required length are made corresponding to the number of the pole and the throws. One end of the wire is connected to a pole or a throw, and the other end of it is connected to the pin of the interface of the controlled object by fixing or inserting. The whole switch device is formed in which the parts of it are indirectly associated by the interface. It can mainly be used in various application where the man-made real-time responses are required, such as the cursor action of computer, the multimedia electroacoustical music performance, password input for user in finance field, game machine controlling, remote-control unit, mobile telephone and the like.

### TECHNICAL FIELD

The present invention relates to a switch, more particularly, to a manufacturing method of a signal generating device which can provide continuous real time response.

### BACKGROUND ART

Nowadays, a conventional keystroke switch used in our life and work is an integral structure in which a single pole and a single throw are integrated together. The interval of the polo relative to the throw is constant when the pole is off from the throw. During the contact procedure, the pole moves in a monodirection towards the throw. In the keypad utilizing such switch, the constant interval of the pole relative to the throw and the pole's monodirection moving towards the throw determine the unidirectivity and verticality of the movement of an operator's finger and the complexity of the movement of fingers, and thus make it true that the contact interface by people is mostly the fingertip when people press the key since only the fingertip is an easier and faster way for pressing keys. For people who touch keys frequently, this will restrict the degree of freedom of the five fingers or both hands, and even the whole body. The static single pose causes the operator easily to be tired and affects the efficiency and interest of the fingers, the hands, the body, the eyes and the brain. Since the pole and the throw are integrated together and the interval of the pole relative to the row is constant, the operation of hands is not flexible and multidirectional, which does not facilitate the operator's relaxation.

The Chinese patent application, CN 1264992A, titled as ‘Annularly-Arranged Mobile Keypad’, filed by Liao, Hua Yong on Feb. 24th, 1999 has disclosed a mobile keypad with single keystroke button and multiple keys. The keypad consists of a keystroke button and a number of keys annularly arranged around the keystroke button. The keystroke button is reset by a reset spring. During operation, the keys annularly arranged around the keystroke button are pressed by operating the keystroke button with a thumb so as to input numerals or perform functional operation. Although the invention employs a single keystroke button to operate, several switches rather than throws within one switch are arranged annularly around the keystroke button, thereby it does not break way from the features that the pole contacts and is off the throw with constant interval and fixed direction. In the meanwhile, new constant interval and fixed direction features are further added on the basis of the existing switch because spring reset is employed for the keystroke button. This structure is still deficient regarding the flexibility of operation.

The problem with which the prior art is confronted is to make the pole within the pole-throw combination have multi-directivity similar to a single finger's movement. The pole in the prior art is bound by a constant interval rule, the constant interval between the polo and the throw determines that the finger's movement will be determined by the direction and interval of the pole relative to the throw. For an operator, it is desirable that the pole moves with the finger and if necessary the throw can be contacted directly. By expanding the constant interval and fixed direction between the pole and the throw to a variable direction and interval between a finger and the throw while the pole is off from the throw, a combination of the pole with the finger can control the whole procedure including the pole's start, contact, and leave with a same action. In this way, the problem of a stroke with constant interval between the pole and the throw in the prior art can be overcome.

Another problem in the prior art is about further reduction of the key's size and an improvement of the operating sensitivity. It is a conflict between further minimization of the key and the operating sensitivity and accuracy. The integral structure with a single throw and a single pole determines usual input methods by pressing keys with multiple fingers or a single finger, such input methods black minimizing the key's size while ensuring the operating accuracy, and also block further minimization of the input means such as keypad.

### CONTENTS OF THE INVENTION

The technical problem the invention wants to resolve is to vary the direction of movement of the pole and the throw, and also the constant interval between the pole and throw in the switch of the prior art. If the pole and the throw are separated rather than integrated in terms of the structure, the feature that the pole is made to contact and be off from different throws with varying direction and varying interval depending on the requirement can solve the problem of constant interval and fixed direction in the prior art. The pole can be moved synchronously with the hand when the pole becomes a part or an extension of the finger, thereby avoiding the procedure that the operator looks for the pole of the switch with fingers and pushes the pole in a fixed direction to make the pole and the throw contact with each other. It is easy for a single finger to move without eyes.

Since the pole is covered on the top of a finger and the size of the throw itself is small, the size of the throw-tray containing the throw is reduced too, a miniature switch device can be realized.

The purpose of the invention is to provide a manufacturing method of a switch device which permits the pole in a dynamic state in which the pole can change the interval and direction relative to the throw before and after each time it contacts the throw, and allows the pole to move within a plane to which the handle is continuously vertical.

The manufacturing method of the employed technical solution consists of three steps;

Firstly, there should be more than two throws arranged uniformly on the same circumference, also the circumference including different levels within a carrier's inner cylindrical surface, an inner circle plane and the throw-carrier's outer plane. With the above conditions satisfied for the carrier fixing the throw, except for the outer plane, it should also be ensured that there is not any movement-resistant object, i.e. there should be a free space in a cylinder or circle plane shape. If the cylinder body is arranged straightly, more than two throws can be arranged uniformly on the bottom plane and the cylindrical surface, except for the top surface, respectively. Thus, the carrier should be a concave object or an annular object, such as a bucket or an encasement. This is the space condition to ensure the pole's movement with changing direction and changing interval, and it is also the difference from the existing manual switches with moving-resistant object. Here the throw tray can be made in a plate shape, annular sleeve shape, annular sheet shape, etc. The inner circular space within the plate shape and the annual sleeve shape is a flat cylinder object. The inner circular space within the circular sheet is a circular plane. The carriers with throws arranged and fled uniformly can be connected to other objects including the pole carrier by means of wedge, tenon or other jointing method, with the purpose of easily carrying and placing during non-operation or positioning during operation. After the position and the carrier of the throw are set, the size of the throw is determined by maximizing the interval between the two closest throws.

Secondly, let the pole in a shape of a long cylinder body, or a hollow pipe and sections with insulation between each other but still integrated together. It should be ensured that the pole and its carrier can be moved synchronously with the finger, and be vertical to the plane when they move within a plane continuously. It is to inosculate the concave space without barrier of the throw carrier. Here the carrier employs an object that can be covered on the top of a single finger. Contrary to the hollow feature of the throw carrier, the space of the pole carrier should be filled so that it can be fixed on a top part of the finger. The carrier is in a shape of cap or sheath, the cap top is spherical or circular truncated cone. The pole can be fixed on the surface of any outer circle as long as it is vertical to the surface and does not affect convenience and easiness of the finger's filling and the operation of in and out. The length and diameter of the pole are determined by inosculating and fitting the throw position set by the circular space of the throw carrier, so that the possibility that the unrelated throws are touched by fault is minimized. It is especially critical for the diameter, and it should be easy for it to be vertical to the plane on which the pole moves.

At last the lead wire is fixed on not only the pole and the throw but also the carrier near to the fix point to avoid its breakup. The other end is connected to the interface of the served object, or the row, column lines of matrix wire layout by fixing or inserting. There may be connection lines between throws, among one or more throw carriers. Poles can also be connected with lines for the convenience of using, like the same effect keys on the keypad. Thus, it can be seen that by fixing and connecting the interface of the controlled object an the other end of the pin, the pole and the throw are integrated together indirectly to form an integral switch device. It is also the difference of the invention from the switches of the prior art in a form that the carriers are integrated together directly or the pole and the throw are integrated together. For example, keystroke, wheel toggle, push and various kinds of pins and hubs. Furthermore, the pole moves continuously with constant interval and fixed direction, and there is not linkage between it and the single finger. So, its service shows a strong dedication feature, similar to sewing for a specific man or building a house according to its environment. It is different from the existing switches which have universality and generality but result in no variety of products and manufacturing methods.

Furthermore, all component elements of the device can be easily changed, added or removed according to practical use, and thus various structures, manufacturing methods and operating methods are derived. All these are for only one purpose that the pole moves within a plane and is in a state of being vertical to the plane continuously, thereby resulting in a dynamic state in which the direction and interval are changed before and after each pole-throw contact. Variable elements include the structural shape, size, number of the poles, throws and the carriers, the positioning of the poles and the throws with respect to the carrier, the materials of the pole, throw and carrier, the number and fashion of the lead wires, the software definition for different kinds of pole-throw contact, etc.

The cylinder shape pole can be ensured spatially to move without any barrier within a plane, and thus certainly can be ensured motionally to insert into and draw out of the throw carrier. Thus, there are a possible space and at the same time a vertical moving space for it to be always vertical to the circular plane. By utilizing such nature, the positioning of throws is not limited to a circle, but can be expanded to multiple levels on the cylinder surface. Thus multiple poles insulated from each other can move within the cylindrical space. A smaller pole is used to change its position vertically to achieve changing pole contacts with the throws at different levels of the circle, and thus more different kinds of pole-throw contacts are generated to fit for more operation situations. It is better to employ throw carrier in annular sleeve shape without a bottom. In a similar way, if the throws are to be placed on the outer surface of the throw carrier, including the outer circular surface, when operating, it can be drawn out of the inner circular space or otherwise can be contacted directly when not inserted, and then can be inserted to change its position.

### DESCRIPTION OF ACCOMPANYING DRAWINGS

FIG. 1 illustrates a structure with three sections of poles integrated together according to the second embodiment of the invention;

FIG. 2 illustrates the visual scenarios of the signal generating by the invention in combination with the existing switch technique;

FIG. 3 illustrates a top view of a throw carrying structure according to the first embodiment of the invention;

FIG. 4 illustrates a front view of a pole carrying structure according to the first embodiment of the invention;

FIG. 5 illustrates the switch circuit diagram of an interface of the controlled object, i.e. a game rocker;

FIG. 6 illustrates the sectional view of a variation of a throw carrying i.e. a throw carrier, according to the second embodiment of the invention;

FIG. 7 illustrates the circular front view of a derived case of a throw carrier according to the second embodiment of the invention.

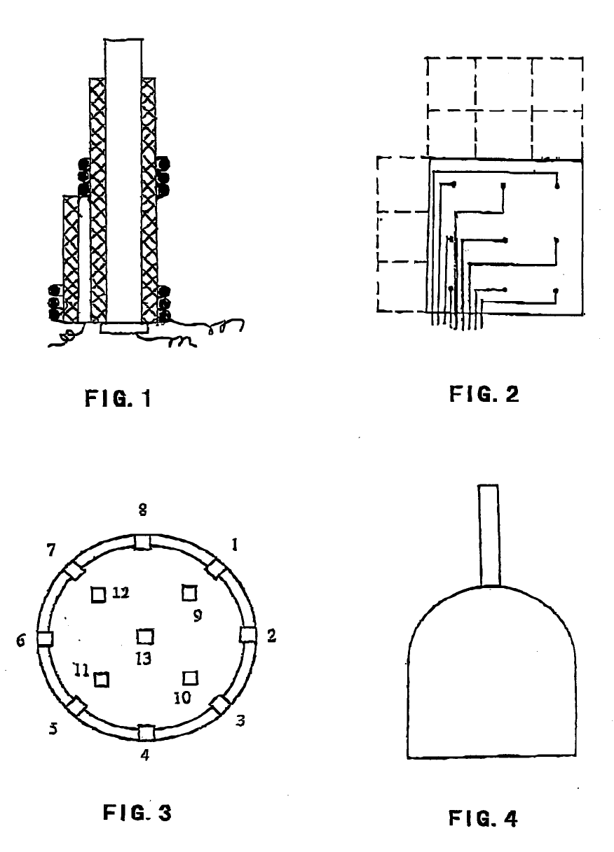

### SPECIFIC EMBODIMENTS

### Embodiment I

Firstly, as illustrated in FIG. 3, 13 throws are placed at the same circumference and on the bottom circular plane. Within the plate shaped throw carrier, a flat cylindrical space is formed. The height of the cylinder is 0.5-1 cm, the diameter is not less than 2 cm. Secondly, as illustrated in FIG. 4, a cylinder polo is fixed on the top of the finger cap and is vertical to the sphere. The pole diameter is 0.5-1.5 mm, the height is 0.5-1.5 cm, and thus forms a pole carrying cap which can be covered on the top part of a finger. At last, 14 lead wires with suitable length are connected to each throw and pole. The other ends of the pole wires are connected to a column of wire pins in the form of 16×8 interface matrix. The other ends of the 13 throw wires are connected to 13 row wire pins in the 16 row lines. Thus, it forms a switch device which permits the pole is in a dynamic state in which the pole can change its interval and direction relative to the throw before and after each time it contacts the throw and always moves within the circular plane and is continuously vertical to the circular plane. The switch is associated indirectly through the rows and columns of the interface matrix to form a whole.

### Example I

13 contact situations can be derived with one pole to 13 throws according to the first embodiment. Similar to a conventional keypad, 13 level signals are gotten. Digital codes corresponding to the throws 1-10 in FIG. 3 are defined by software, 11 is defined as deleting a single, 13 is defined as confirming, 12 is defined as deleting all. Only one person is allowed to view with the help of the digital display, similar to the situation of watching the cat eye on the gate. The enlarged figure of the defined code throw position is shown aside for entering passwords by financial customers, the nature of smallness and operating without eyes determines its privacy during operation.

Similarly, if only 8 contacts of the pole with throw 2, 4, 6, 8, or 9, 10, 11, 12, i.e. 8 level signals, are utilized, as illustrated in FIG. 3, the corresponding definitions are directional codes, i.e. similar to the directional keys such as up, down, left, right. Two kinds of moving, i.e. on the bottom plane or on the circumference, can be selected during operation. If the wires with the same effect, i.e. 8 and 12, 6 and 11, 4 and 10, 2 and 9, are connected, only 4 signals need to be defined. The cursor on the computer can be operated by making the pole top or the cylinder in contact with the throw.

### Embodiment II

Firstly, as illustrated in FIG. 6, only 5 throws, throw 2, 4, 6, 8, 13, in FIG. 3 are employed, one is at the center of the bottom circular plant, the other 4 are at the cylinder. Two of the 4 throws are at one of two levels of circumference respectively. The lower two throws is 4 mm from the inner bottom, the height of the plate is suitable for the height of the pole.

Secondly, a integral structure with 3 sections of poles is illustrated, wherein the poles are insulated from each other. The manufacturing method is to paint the pole with insulation paint or cover it with a plastic pipe from the top 2-4 mm to the bottom. The thickness of the pipe wall or the paint is not more than 0.3 mm. A wire with paint removed and with the diameter of 0.2-0.4 mm is wound tightly from the top 4-7 mm downwards. A situation in which the hollow pole is sleeved outside the solid pole and both poles are non-conductive is formed. The length of the middle pole in a pipe shape is 3-5 mm, paint is kept for the lead wire in the axis direction and the lead wire is kept insulating from the tail pole. A wire with paint removed and the diameter of 0.2-0.4 mm is wound from 5 mm away from the middle pole, and thus resulting in a pole in a pipe shape similar to the middle poles its length is 5 mm, and paint is kept for the lead wire. A solid pole tail is fixed on the top of the finger cap and is made vertical to the sphere. The pole length should ensure the pole can contact the throws and is easy for flexible operation when it is vertical to the circular plane and moves on the plane, it is also true for the throw sheet size.

At last, 8 wires of suitable length are connected to 3 poles and 5 throws, and fixed on near carriers in order not to be broken. The other ends of these 8 wires are connected to the pins of interface of the controlled objects to form a switch device indirectly associated. To generate a cursor control, here the top pole and the inner bottom throw can be put aside. The lead wires of the middle pole and the tail pole are connected to one column wire. 4 throws are connected to 4 row wires, the switch device is generated after defining the directional codes. If the service object is changed, the connection with the interface also should be changed accordingly. The method is as follows.

### Example II

If the controlled object is the switch circuit diagram of the game rocker, as illustrated in FIG. 5, the pins of the interface are situated therein, the lead wire of the tail pole is connected to point B, the lead wire of the middle pole is connected to point A. If FIG. 3 is replaced by FIG. 6, the throws at positions 4, 8, 2, 6 are connected to pins 2, 4, 1, 3 respectively to form the function of controlling a game direction. The top pole and the inner bottom throw form a confirm switch, the interfacing pin of its lead wire is not shown in this figure. But it does not affect a complete disclosure of the invention since it is in the prior art. This example shows that the switch device of the invention is made to have an indirect associated whole by controlling the controlling circuit of a rocker. It also shows that different service objects make the elements in the switch device varied.

### Example III

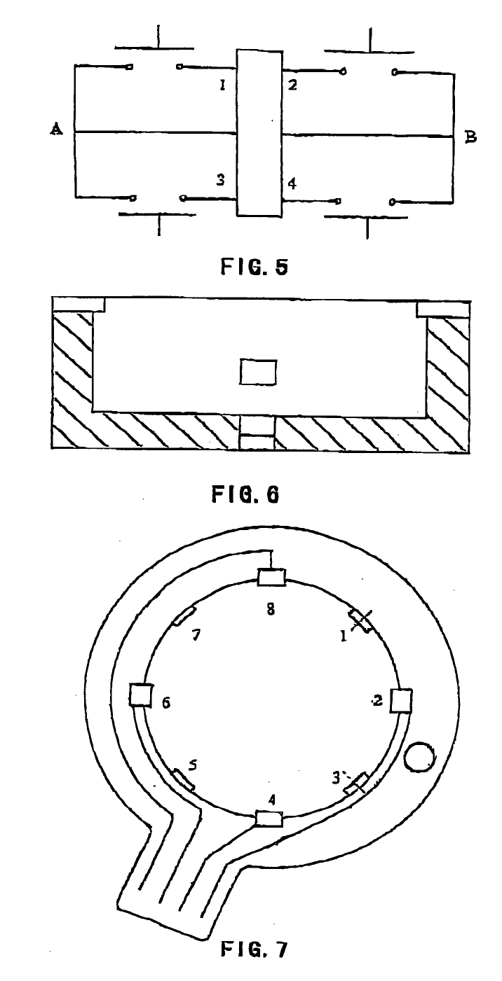

Firstly, as shown in FIG. 7, 8 throws are uniformly placed on the same circumference in a state that one positive throw alternate with one inverse. The throw carrier is in a circular sheet shape, the inner circle shows a circular plane space with no barrier. The lead wires of both the positive throw and the inverse throws are attached onto the front and opposite planes at the hub point. It is similar to the matrix layout of a computer keypad attaches onto a plastic sheet. The throw sheet occupies the inner circle so that the interval between two consecutive throws is maximized and they cannot contact each other. Here the throw width is 1-2 mm, the length is 3-5 mm. The thickness of the circular sheet is 0.5-1 mm, the diameter of the inner circle is not smaller than the forefinger, and the diameter of the outer circle is not wider than two fingers. The extending stick between the throw 4 and the throw 5 is provided for wires and is inserted into a hub in which 8 lead wires have been fixed with one end. A small hole is arranged near the outer circle and between the throw 2 and the throw 3 for positioning and connecting while not in use or during operation. The outer circle of the annular sheet can be held by the left hand or fixed by inserting at a position that is convenient for the right hand to move the pole.

Secondly, a structure of the finger cap with pole, in which 3 poles are integrated together shown in example II, is employed. Synchronous moving with the single finger and moving in a circular plane spatially with no barrier can be ensured, and it is maintained vertical to the circular plane during continuous operation. It has shown the feature that the pole is in a dynamic state in which the direction and interval of the pole to the throw can be changed before and after contacting the throw each time. It can also be seen that it can be fully ensured that the pole can be inserted into and drawn out of the inner circle of the annular sheet i.e. it is possible that the pole spatially moves vertical to the circular plane. By means of such possibility, a smaller pole is moved vertically to achieve the function that 3 poles can changeably contact 8 throws. There will 3×8=24 throw contacting possibilities, i.e. it means that 24 levels can be generated to define codes.

At last the 3 poles are fixed in the hub with suitable long lead wires, and suitable long wires are also extended to connect to the pins of the 3 column wires of an interface matrix. The other ends of the 8 throw lead wires with the ends connected to the hub are connected to the pins of the 8 row wires of the matrix. For the 24 level signals thus generated, the middle pole contacting the 8 throws can be defined by the audio card or other electroacoustical software as accordatura C, D, E, G, A, B musical scale plus a higher octaves scale and a lower octaves scale. The top pole contacting the 8 throws can be defined as high octaves scale, an additional one can be defined as one of a low octaves scale and a further higher octaves scale. The tail pole contacting the 8 throws is low octaves scale, an additional one is treated as above. Thereby electroacoustical performance in computer multimedia can be done. If it is desirable to define more functional enjoyment, another same throw carrier can be made integrated on a plane by fixing and connecting two annular sheets via a small hole arranged between the throw 2 and throw 3 and near the outer circle. The newly generated 24 level signals are defined randomly according to needs. From this example it can be seen that with an increase of the amount of the elements such as throws and poles of the switch device, multiple increase of the categories of level signals can be obtained, this means that the range of application of the switch device has a potential of being expanded.

### Example 4

If the feature that contacting throws move within the same plane is combined to the existing feature that the keypad contacts the throw vertically in a constant interval, the minimization and moving without eyes can be shown in another way.

The manufacturing method is: firstly 9 poles and 9 throws are arranged according to a matrix, as normal square, the 18 contact points (both poles and throws are set in a thin, flat, and small shape) and respective lead wires are attached to 0.3 mm inside the thin plastic sheet, the plastic sheet is the carrier of poles and throws. A throw carrier is bigger than a pole carrier, the size of the carrier attached to the pole is similar to an adult's nail, in a square shape.

Secondly, 18 lead wires are connected to wire ends with suitable length. The other end is connected correspondingly to the pins of the row line and column line of the matrix of the interface to generate 9 level signals. Here, the switch device has been completed regarding its structure. In practical application, however, it is possible to generate another 36 level signals.

At last, total 45 possible level signals are assigned with definitions based on the requirement.

The signals are generated as follows: One face of a pole carrier and a throw carrier is made with higher friction force to some extent than the other face. During the operation two sheets are lapped over with the rubbed face towards outside. Then, they are pinched by the thumb and the forefinger side at a suitable position, thereby resulting in a form that the pole is in adherence with the skin. The pole can be pushed by the thumb to one of the 9 square throws to generate this signal, it is also true for the other 8 throws. If the pole carrier is slightly slipped by the thumb to a place shown by the dotted line on the left side in FIG. 2, and then is pressed by the thumb to generate 6 new level signals. As shown in FIG. 2, the pole carrier can be slipped slightly to the upper dotted line to further generate 3 level signals. Actually 9 kinds of level signals can be generated if it is slipped towards one direction shown in this figure to a desired position. So, it is conceivable that 4×9=36 situations for contacting the throw powerfully by the thumb ran be generated if the pole carrier is slipped in four directions, i.e. up, down left and right. Totally 5×9=45 kinds of level signals can be generated by plus 9 original position for defining required codes. If capacitance switch is not employed, small holes ran be made on the attached films of the pole and the throw for operating the touch. If the throw carriers are is expanded to 3 throws arranged respectively in four directions, 12 signals can be generated by moving the pole outward one row, and 36 signals for 3 rows, totally 45+36=81 signals can be generated. If the throws are expanded further so that throws are arranged fully at the crisscross corner space, another 36 signals can be generated. A derivation and multiplication process can be seen from this. Existing integration technique can be utilized in this example to combine the 100 lines into one.

1. The manufacturing method of a switch device showing changeable interval, need to uniformly arrange more than 2 throws on the same circumference and fixed onto corresponding circular carriers, characterized in that: firstly, a number of throws are fixed on the inner cylinder surface of a flat cylinder plate body, secondly the poles in cylinder shape are fixed on the top of the carrier in the cap shape which can be covered on the top of a single finger, at last necessary lead wires are connected to respective throws and poles, the other end is connected to the pin of the interface of the controlled object by fixing or inserting to form a integral switch device in a indirectly associated form.

2. The manufacturing method of the switch device showing changeable interval according to claim 1, characterized by forming a capability that the pole can move with changeable direction and changeable interval within the plane before and after each time contacting the throw and always be vertical to the plane.

3. The manufacturing method of the switch device showing changeable interval according to claim 1, characterized in that the manufacturing method and combining method of each of elements and the integrated derivation manufacturing method that can be applied are derived from different interfaces or operating methods of the controlled object.

4. The manufacturing method of the switch device showing changeable interval according to claim 1, characterized in that arrangement of the throws and the poles on the carrier plane is expandable.

5. The manufacturing method of the switch device showing changeable interval according to claim 1, characterized in that the number of the poles, the throws and the carriers can be increased.

6. The manufacturing method of the switch device showing changeable interval according to claim 1, characterized in that the pole carrier and the throw carrier can be integrated together, also, more than one same type of carriers (i.e. pole carrier or throw carrier) can be integrated together; the throw wire for integrated structure or separate store can be connected; the pole wire for integrated structure or separate structure can be connected.

7. The manufacturing method of the switch device showing changeable interval according to claim 6, characterized in that the integrated structure of 3 poles in a cylinder shape is variable and the main rigid material may be non-metal material.

8. The manufacturing method of the switch device showing changeable interval according to claim 1, characterized in that the size and shape of pole, throw and carrier, and the code definition of pole-throw contact type are variable and selectable.

9. The manufacturing method of the switch device showing changeable interval according to claim 4 characterized in that the function of changing the pole and throw during operation and the corresponding effect of multiplying the type of throw contacting are produced.

10. The manufacturing method of the switch device showing changeable interval according to claim 1, characterized in that it is suitable for various interfaces of the sites requiring the man-made real time response.
